(19) United States
(12) Patent Application Publication
(10) Pub. No.: US 2009/0261661 A1
(43) Pub. Date: Oct. 22, 2009

(54) POWER CONTROL DEVICE FOR APPARATUSES THAT EMPLOY STANDBY POWER

(76) Inventor: Brenda Ann Finneran, Wooster, OH (US)

Correspondence Address: WALKER & JOCKE, L.P.A., 231 SOUTH BROADWAY STREET, MEDINA, OH, 44256, US

(21) Appl. No.: 12/186,888

(22) Filed: Aug. 6, 2008

Related U.S. Application Data
(60) Provisional application No. 61/046,955, filed on Apr. 22, 2008.

(51) Int. Cl. H01H 7/00

(52) U.S. Cl. 307/141.8

(57) ABSTRACT

An apparatus is disclosed herein that includes a housing, wherein the housing has a front and a back, wherein the housing includes first electrical receptacles, a switch, and a timer module. The first electrical receptacles are positioned on the front of the housing and are configured to receive first prongs of an electric plug, and the switch may be responsive to the timer. The apparatus can further include second prongs that correspond to the first electrical receptacles, wherein the second prongs re coupled to the housing and are configured to be received by second electrical receptacles of an outlet socket. The switch, when closed, is operative to electrically couple at least one of the first prongs with at least one of the second electrical receptacles. When open, the switch is operative to prevent electrical coupling of the at least one of the first prongs with the at least one of the second receptacles. The timer is operative to cause the switch to be opened and closed.

### RELATED APPLICATION

This application claims priority to U.S. Provisional Patent Application Ser. No. 61/046,955, entitled “POWER CONTROL DEVICE FOR APPARATUSES THAT EMPLOY STANDBY POWER”, and filed on Apr. 29, 2008. The entirety of this application is incorporated herein by reference.

### BACKGROUND

Apparatuses that operate in a “standby power” mode consume a significant amount of electric power, particularly when considered collectively. More specifically, many devices that are “always on” while seemingly “off” draw power so that the devices can be employed by the user on demand. In an example, an inefficient device may use as much as twenty watts of power when in standby mode. While such wattage by itself is relatively insubstantial, when billions of appliances are considered, the waste of power is significant.

### SUMMARY

The following is a brief summary of subject matter that is described in greater detail herein. This summary is not intended to be limiting as to the scope of the claims.

An apparatus is disclosed herein that includes a housing, wherein the housing has a front and a back, wherein the housing includes first electrical receptacles, a switch, and a timer module. The first electrical receptacles are positioned on the front of the housing and are configured to receive first prongs of an electric plug, and the switch may be responsive to the timer. The apparatus can further include second prongs that correspond to the first electrical receptacles. For example, the second prongs can extend from the back of the housing and can be configured to be received by second electrical receptacles of an outlet socket. In another example, a cable or cables may extend from the back of the housing, and the second prongs may extend from a plug that is at an end of the cable. In such an embodiment, the apparatus can be placed proximate to an electrical device and remotely from an outlet socket. The switch, when closed, is operative to electrically couple at least one of the first prongs with at least one of the second electrical receptacles. When open, the switch is operative to prevent electrical coupling of the at least one of the first prongs with the at least one of the second receptacles. The timer is operative to cause the switch to be opened and closed.

Also described herein is a methodology that includes acts of producing a housing, wherein the housing includes a front, a back, an interior, and first electrical receptacles that are configured to receive first electrical prongs of an electrical apparatus. The method also includes the acts of placing second electrical prongs on the back of the housing (e.g., directly on the back of the housing and/or coupled to the electrical housing by way of a cable), wherein the second electrical prongs correspond to the first electrical receptacles and are configured to be received by second electrical receptacles of an electrical wall outlet, and placing a timer in the interior of the housing. The methodology may further include the act of placing a switch in the interior of the housing, wherein the switch is operatively coupled to the timer. Prior to the timer being initiated, the timer may be operative to place the switch in a position to prevent electrical current from being provided to the first electrical receptacles from the electrical wall outlet. Once initiated, the timer may be operative to place the switch in a position to allow electrical current to be provided to the first electrical receptacles from the electrical wall outlet. After passage of a defined amount of time the timer may be operative to place the switch in a position to prevent current from being provided to the first electrical receptacles from the electrical wall outlet.

Other aspects will be appreciated upon reading and understanding the attached figures and description.

### BRIEF DESCRIPTION OF THE DRAWINGS

FIG. 1 is an example apparatus for controlling power used by electrical devices that employ standby power.

FIG. 2 is an example view of a back of an example apparatus for controlling power used by electrical devices that employ standby power.

FIG. 2a is another example view of a back of an example apparatus for controlling power used by electrical devices that employ standby power.

FIG. 2b is another example view of a back of an example apparatus for controlling power used by electrical devices that employ standby power.

FIG. 3 is an example view of an interior of an example apparatus for controlling power used by electrical devices that employ standby power.

FIG. 4 is an example apparatus for controlling power used by electrical devices that employ standby power.

FIG. 5 is an example apparatus for controlling power used by electrical devices that employ standby power.

FIG. 6 is an example apparatus for controlling power used by electrical devices that employ standby power.

FIG. 7 is an example apparatus for controlling power used by electrical devices that employ standby power.

FIG. 8 is an example apparatus for controlling power used by electrical devices that employ standby power.

FIG. 9 is an example apparatus for controlling power used by electrical devices that employ standby power.

FIG. 10 is an example configuration of a plurality of electrical devices.

FIG. 11 is an example remote control.

FIG. 12 is an example apparatus for controlling power used by electrical devices that employ standby power.

FIG. 13 is an example methodology for controlling power used by electrical devices that employ standby power.

### DETAILED DESCRIPTION

Described herein are apparatuses, methods, and articles of manufacture that facilitate reducing power consumed by electrically powered devices when such devices are not being used. The apparatuses, methods, and articles of manufactured are well-suited for use with many consumer-level and business office-level apparatuses, including but not limited to toasters, charging devices (e.g., cellular telephone chargers, chargeable electric razors, charger for a personal digital assistant, . . . ), televisions, digital video recorders, set-top boxes, stereos, DVD players/recorders, VCRs, curling irons, clothes irons, computers, hair dryers, printers, scanners, among others. In an example, aspects described herein pertain to automatically preventing electric power from reaching a device in standby mode by opening a circuit that electrically couples the device to a power outlet (e.g., a 120 volt alternating current outlet) after passage of a defined period of time.

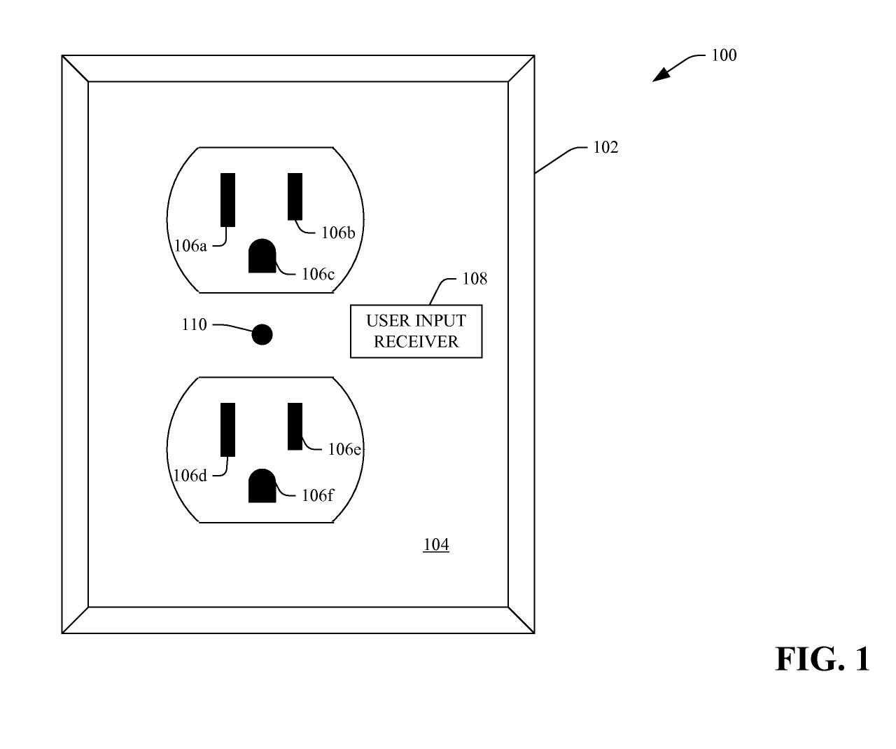

Referring now to the drawings, where like numerals represent like elements throughout, apparatuses, methods, and articles of manufacture that facilitate reducing power consumed by electrically powered devices when such devices are not being used are described in detail. With reference particularly to FIG. 1, an example apparatus 100 is illustrated. The apparatus 100 includes a housing 102, wherein the housing 102 may be made of a plastic material, a carbon fiber material, or other suitable material. In this depiction, a front 104 of the housing is illustrated—as will be discussed below, the housing 102 also includes a back and an interior.

The housing includes first electrical receptacles 106a, 106b, 106c, 106d, 106e, and 106f, which are collectively referred to herein as first electrical receptacles 106. The first electrical receptacles 106 are illustrated as including “neutral” receptacles 106a and 106d, “hot” receptacles 106b and 106e, and “ground” receptacles 106c and 106f. As such, the first electrical receptacles 106 are configured to receive first prongs of an electric plug that is employed in connection with providing power to an electrical device, such as an electrical device discussed above.

The apparatus 100 further includes a user input receiver 108 that receives user input pertaining to an amount of time that power is to be provided to the electrical device. For instance, the input receiver 108 may be operatively coupled to a timer (not shown) that is in the interior of the housing 102. The input receiver 108 may be, for instance, a depressible button, a rotatable dial, a slider, a wireless interface for receiving wireless communications, a touch pad (e.g., that detects movement of a finger), a microphone for detecting voice commands, or other suitable apparatus that can be used to receive user input.

The apparatus 100 also includes an aperture 110 that is configured to receive a mechanism that facilitates coupling the apparatus 100 with an electrical wall outlet, such as a standard 120 volt alternating current outlet. For instance, the aperture 110 may be configured to receive a threaded screw, wherein turning of the threaded screw places the apparatus 100 in close proximity to a wall. Accordingly, the apparatus 100 may be aesthetically pleasing and may consume relatively little space. Other fastening mechanisms may be used, including clips or adhesives, among other possible fastening mechanisms.

Furthermore, while shown as including two sets of electrical receptacles 106, it is to be understood that the apparatus 100 may include more or fewer electrical receptacles. In addition, one or more electrical receptacles may not include a ground receptacle. In addition, while shown as including the aperture 110, it is to be understood that the apparatus 100 may include multiple apertures. In another example, the apparatus may include no apertures and may be coupled to an electrical wall outlet by other fastening mechanism(s).

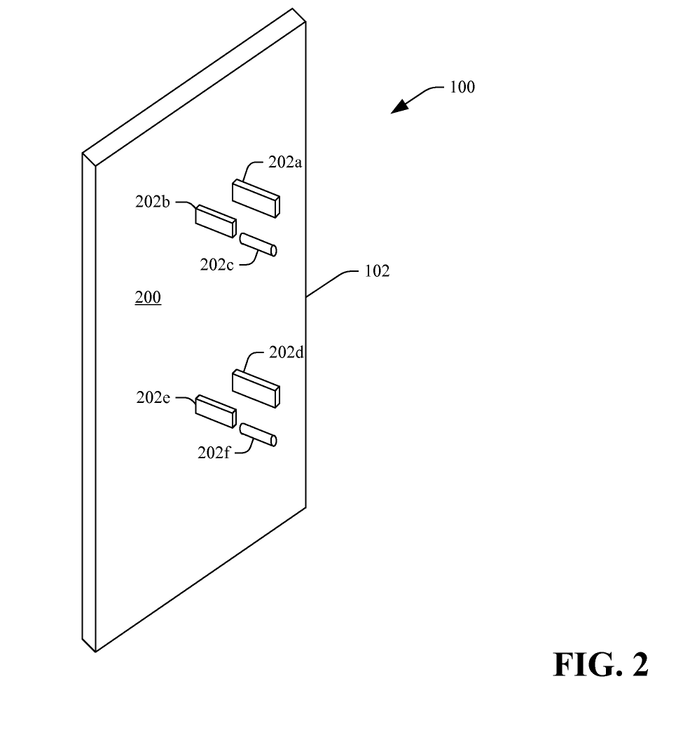

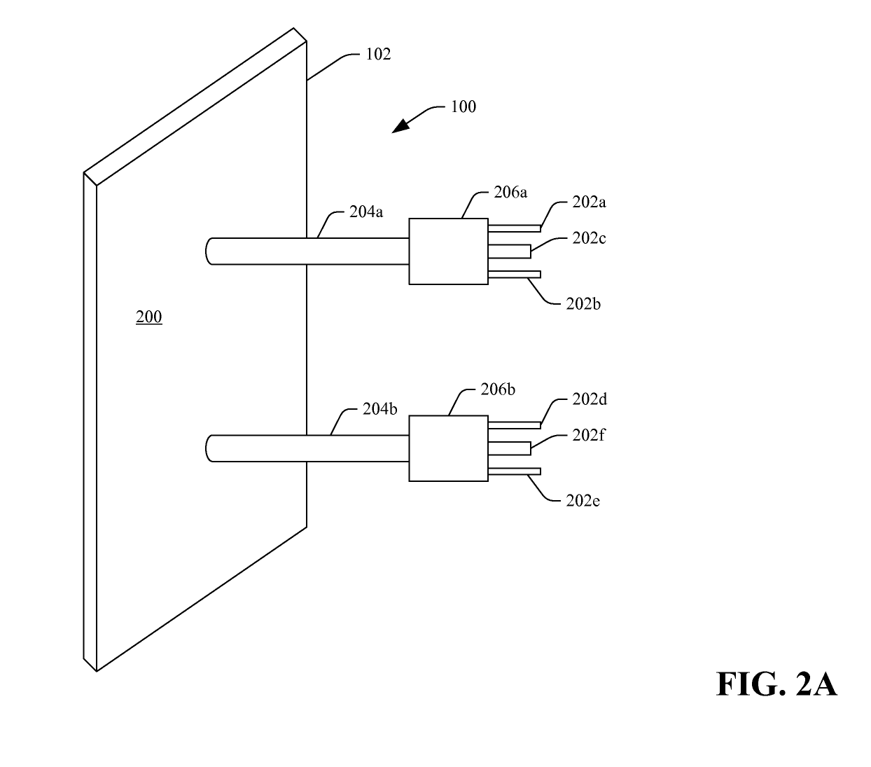

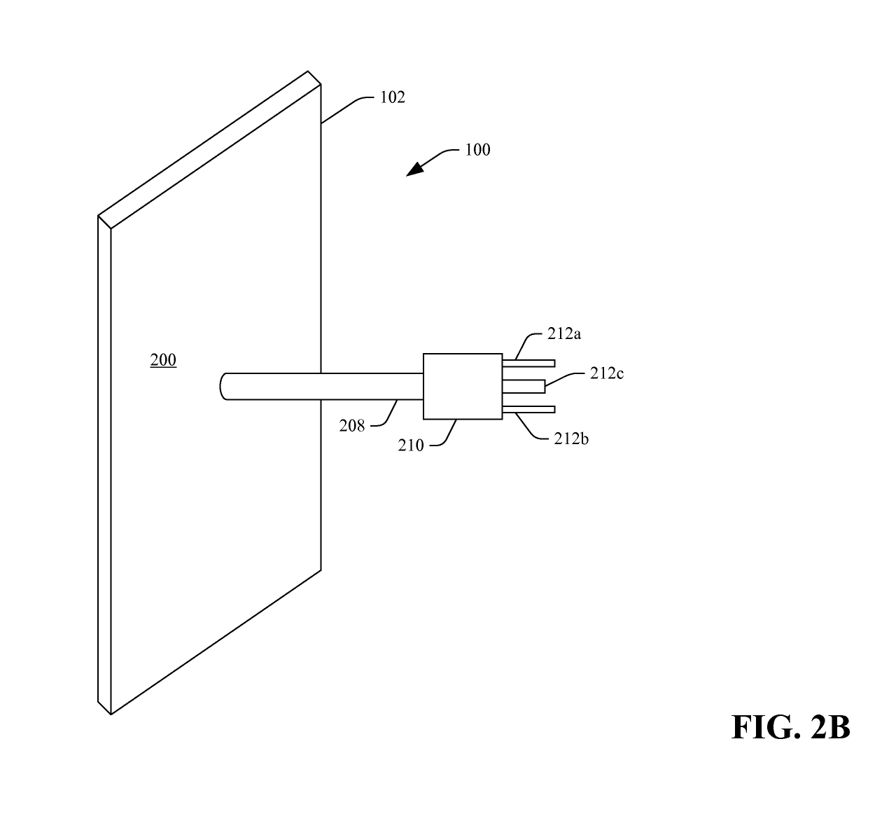

Now referring to FIG. 2, a back 200 of the housing 102 of the example apparatus 100 is illustrated. As shown, the apparatus 100 includes second prongs 202a, 202b, 202c, 202d, 202e, and 202f, collectively referred to as second prongs 202, that extend from the back 200 of the housing 104. The second prongs 202 correspond to the first electrical receptacles 106, and are configured to be received by second electrical receptacles of an electrical wall outlet (not shown). More particularly, the prong 202a corresponds to the electrical receptacle 106a, the prong 202b corresponds to the electrical receptacle 106b, the prong 202c corresponds to the electrical receptacle 106c, the prong 202d corresponds to the electrical receptacle 106d, the prong 202e corresponds to the electrical receptacle 106e, and the prong 202f corresponds to the electrical receptacle 106f. As noted above, however, more or fewer prongs may extend from the back 200 of the housing 102 than what is shown, and the prongs 202 may or may not include “ground” prongs.

In another embodiment that will be described in greater detail below, the second prongs 202 may not extend directly from the back 200 of the housing 102. Instead, one or more cables (cords) may extend from the back 200 of the housing 102 and the second prongs 202 may extend from a plug that is at an end of the cable (an opposite end of the cable from the end of the cable that is coupled to the housing 102). It can be discerned that a single cable may extend from the back 200 of the housing 102, or multiple cables may extend from the back 200 of the housing 102. Using cables allows the apparatus 100 to be placed more proximate to electrical devices and somewhat remotely from a wall outlet socket. These example embodiments are illustrated in FIGS. 2A and 2B.

More specifically, FIG. 2A depicts the back 200 of the housing 102 and two cables 204a and 204b extending from the back 200 of the housing 102. Plugs 206a and 206b are coupled to the end of the cables 204a and 204b, respectively, and the electrical prongs 202a-202f extend from the plugs 206a and 206b, respectively.

With respect to FIG. 2B, a single cable 208 extends from the back 200 of the housing 102, and a plug 210 is coupled to an end of the cable 208. A single set of electrical prongs 212a, 212b, and 212c extend from the plug 210. In FIGS. 2, 2A, and 2B, the apparatus 100 facilitates reducing use of power with respect to apparatuses that use standby power.

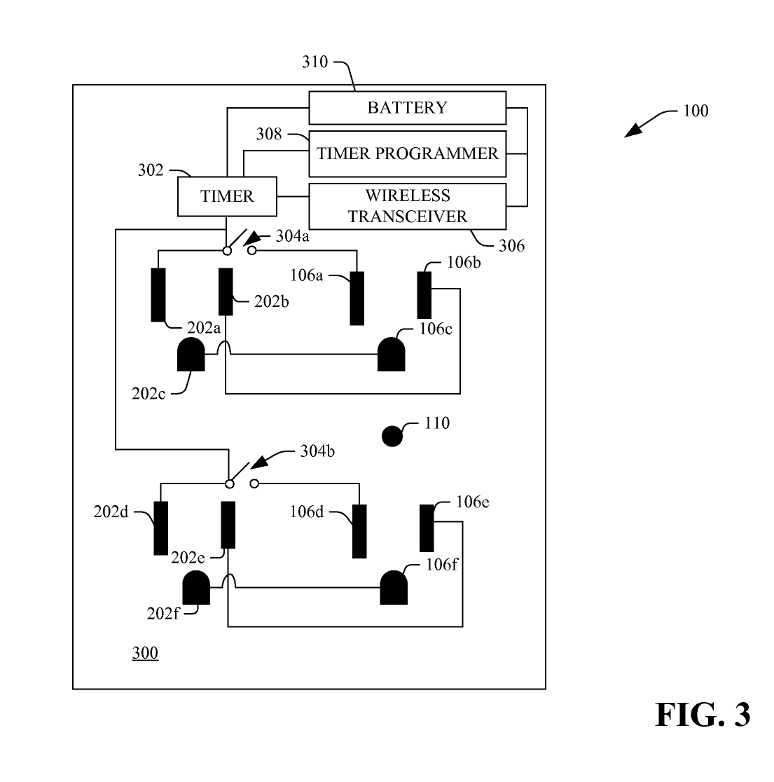

Now turning to FIG. 3, an example interior 300 of the housing 102 is illustrated. The interior 300 includes a timer 302 that is configured to be set in accordance with user input received by the input receiver 108 (FIG. 1). For instance, the timer 302 may be mechanical in nature, and may be set by the user by rotating a rotatable dial. The timer 302, when initiated, may be operative to generate an output after passage of a defined amount of time (e.g., defined in accordance with input received by the input receiver 108). In addition, the timer 302 may be operative to generate an output upon being initiated.

The interior 300 of the housing 102 also includes switches 304a and 304b that are responsive to the timer 302. More specifically, the switches 304a and 304b may be used to electrically couple and decouple at least one of the first electrical receptacles 106 with at least one of the second prongs 202. When the switch 304a is closed, the electrical receptacle 106a is electrically coupled to the prong 202a, the electrical receptacle 106b is electrically coupled to the prong 202b, and the electrical receptacle 106c is electrically coupled to the prong 202c. Accordingly, if the second prongs 202 are received by at a wall outlet, and prongs of a plug used to provide power to an electrical device are received by the electrical receptacles 106, and the switch 304a is closed, electrical power will be provided to the electrical device. If, however, the switch 304a is open, then power will not be provided to the electrical device (e.g., it will be as if the electrical device has been unplugged).

In operation, the input receiver 108 (FIG. 1) can receive input from a user pertaining to a desired amount of time during which power is to be provided to an electrical device. The timer 302 can be initiated and set for the desired amount of time, and may generate an output, may alter a mechanical state of a switch, and/or the like. The switch 304a, in response to the timer 302, can close, thereby allowing power to be provided from a wall outlet to the electrical device. After passage of the desired amount of time, the timer 302 may be operative to cause the switch 304a to open, thereby preventing power from being delivered to the electrical device.

The interior 300 of the apparatus 100 may optionally include a wireless transceiver 306 that can facilitate reception of user input from a remote location (e.g., from a remote control). Pursuant to an example, a remote control may be used in connection with initializing/setting the timer 302, and the wireless transceiver 306 can be configured to receive communications from the remote control. In another example, the wireless transceiver 306 may be configured to output wireless communications that may be received by other wireless transceivers in other apparatuses. For instance, the wireless transceiver 306 may be used in connection with initializing/setting another timer in another apparatus.

The interior 300 of the apparatus 100 may also optionally include a timer programmer 308 that can be used to program the timer 302. For instance, if the timer 302 is a digital timer, the timer programmer 308 can be employed to initialize the timer and program the timer to generate an output after a user-defined amount of time has passed.

The interior 300 of the apparatus 100 may also optionally include a battery compartment 310 that is configured to receive a battery. A battery (not shown) when placed in the battery compartment 310 may be used to provide electrical power to the timer 302, the wireless transceiver 306, the timer programmer 308, and/or any other portions of the apparatus 100 that may utilize electrical power. Use of a battery to provide power to internal portions of the apparatus 100 may reduce receipt of electrical power from a wall unit (e.g., the apparatus 100 may not operate in standby mode).

While the example apparatus 100 has been described in detail above, it is to be understood that various alternative embodiments are contemplated and are intended to fall under the scope of the hereto-appended claims. For example, the timer 302 may be a mechanical timer as discussed above. For instance, the timer may include one or more clockwork-type mechanisms, such as an escapement and a spring that can be used to set a time for the timer 302. Further, a flat beater may spin against air resistance, such that the timer 302 may include aspects of egg-timers. In yet another example, a winding apparatus can be used to initialize/set the timer 302, wherein rotation of a dial winds a spring, and an amount that the spring is wound corresponds to an amount of time that passes prior to the timer 302 causing the switch 304a to be opened.

The timer 302 may also be an electromechanical timer. An example of such a timer includes a metal finger that comprises two metals with differing rates of thermal expansion. Electric current flows through the finger and heats the finger, causing one portion of the finger to expand more than the other portion of the finger (thus causing the finger to bend). When it is detected that the finger has made contact with a contact point due to the bending, a particular amount of time has passed. The timer 302 may also include a cam timer that uses a small synchronous AC motor turning a cam against a comb of switch contacts. Such a cam timer may be combined with electrical relays to create an electromechanical controller.

In yet another example, the timer 302 may be a digital timer that, for instance, includes a quartz clock. A digital timer may be implemented as a single-chip system.

Furthermore, a timer similar to those used in computers may be used (e.g., software sets a digital counter to a number corresponding to a certain unit of time, and when the counter reaches zero an output is generated). Still further, the timer 302 may be or include a hardware timer.

While the apparatus 100 is illustrated as including a single timer to control multiple switches 304a and 304b, it is to be understood that each switch may have a timer that corresponds to the switch. Therefore, in an example, the apparatus 100 may include two timers: one timer that is electrically coupled to the switch 304a and one timer that is electrically coupled to the switch 304b.

With respect to the switches 304a and 304b, the default position of these switches may be “open”, such that electrical power does not flow through the apparatus 100. Upon receipt of user input, at least one of the switches 304a or 304b can be closed, thereby allowing electrical power to flow through the apparatus 100 to an electrical device. In an example embodiment, the switches 304a and 304b can include a bimetal thermostatic type disk, such as the 30M disk manufactured by Therm-o-Disc, Inc.®, a subsidiary of Emerson Electric Co®. The disk can be manually set and then after the defined amount of time has passed (as determined by the timer 302), the disk is triggered to change position (e.g., through electrical power and/or heat), causing the disk to revert to a position that results in an open circuit. In other words, a user can cause a disk to change position to close a circuit. Power flowing through the disk heats the disk, which can cause the disk to revert to a default position (where the circuit is open).

In another example, one or more of the switches 304a or 304b may be, include, and/or operate in connection with a modified rack and pinion pushbutton mechanism. In an example, depression of a button (e.g., located on the front 104 of the housing 102) can wind a mainspring. As energy from the mainspring is released and a corresponding rack reverses direction, continuous contact can be made on a shaft on an opposite side of the rack, thereby closing the circuit and allowing electrical current to flow. When a contact reaches a “stop” position at an end of the rack, the circuit can be opened (e.g., the stop may have a non-conductive coating or composition).

Furthermore, rather than including a battery compartment 310, the interior 300 of the apparatus 100 may include a capacitor or super capacitor (or other capacitive device) that can retain electrical charge after the switches 304a and 304b are opened. The capacitor or super capacitor may then discharge current to provide electrical power to devices in the apparatus (e.g., the timer programmer 308, the timer 302, and/or the wireless transceiver 306, among others).

In addition, while the first electrical receptacles 106 and the second prongs 202 are shown as being misaligned, it is to be understood that the first electrical receptacles 106 and the second prongs 202 may be substantially aligned.

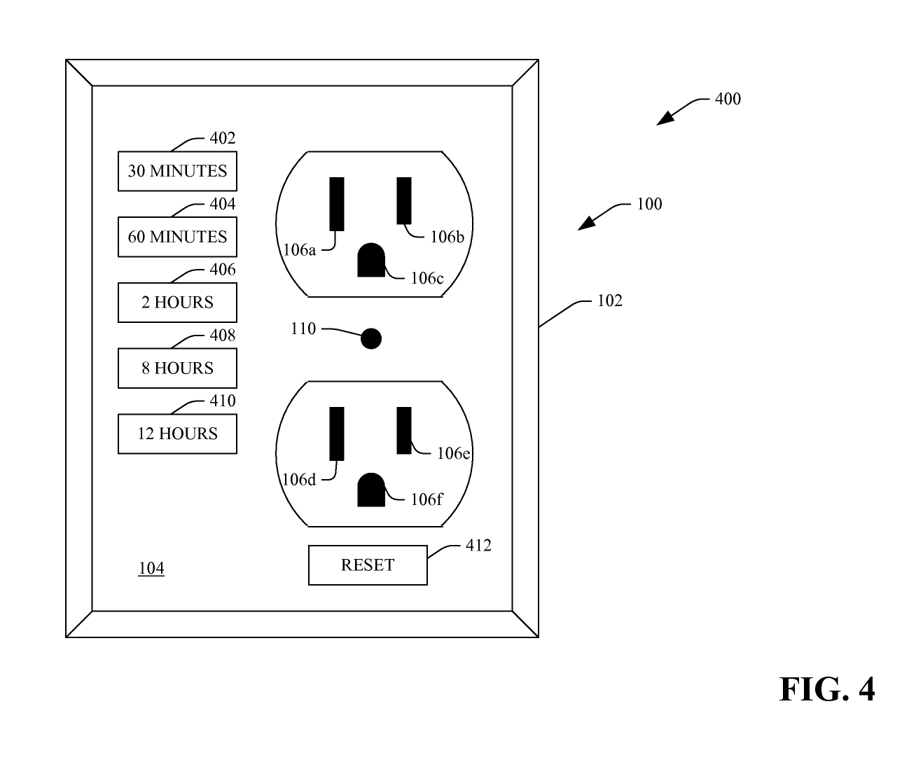

Referring now to FIG. 4, an example embodiment 400 of the apparatus 100 is illustrated. In this embodiment 400, the apparatus 100 includes multiple depressible buttons 402, 404, 406, 408, and 410, wherein each of the depressible buttons corresponds to a particular period of time. Depression of one the depressible buttons 402-410 can initiate the timer 302 (FIG. 3) and set the timer 302 for the time that corresponds to the depressed button. Upon the timer 302 being initiated, the switches 304a and 304b can be closed, thereby allowing electrical power to be delivered to an electrical device plugged into the apparatus 100 by way of a wall outlet. Once the selected time has passed, the timer 302 can be operative to cause the switches 304a and 304b to close, thereby preventing electrical power from being delivered to the electrical device (even though prongs of the electrical device are received by a set of the first electrical receptacles 106).

Pursuant to an example, an individual may wish to charge a portable telephone, and may plug a charging device into a set of the first electrical receptacles 106 (e.g., electrical receptacles 106a and 106b and optionally receptacle 106c). Fully charging the portable telephone may take approximately one and a half to two hours—accordingly, the individual may depress the button 406, which initiates the timer 302 and sets the timer 302 for two hours. The switches 304a and 304b are closed, allowing electrical power to be provided to the charging device. After two hours, the timer 302 may generate an output and the switches 304a and 304b can be opened—thus, the portable telephone is fully charged, but the charging device is not needlessly pulling electrical power from a wall outlet. Moreover, the individual need not unplug the charging device when not in use. The various buttons 402-410 may be particularly well-suited for numerous devices. For instance, the button 402 may be well-suited for toasters, curling irons, and other devices that often remain plugged into a wall outlet but are in use for a relatively short period of time. In another example, the button 410 may be particularly well suited for electrical devices that are frequently used over long periods of time, such as a television or computer.

The apparatus 100 may also include a reset button 412 that may reset the apparatus 100 to a default mode (e.g., when the switches 304a and 304b are open). For instance, an individual may depress the button 410 with thoughts of watching a television for an extended period of time. An unexpected development, however, may cause the individual to quit watching the television with no immediate prospects for returning to watching the television. Accordingly, the individual may depress the reset button 412 to place the apparatus 100 in the default mode. Furthermore, the individual may initially depress a first button and thereafter reset the timer 302 for a different time by depressing a second button. For instance, the individual may initially depress the button 402 to set the timer at thirty minutes, and before the thirty minutes has passed, depress the button 404 to reset the timer to sixty minutes (without opening the circuits 304a and 304b). In another example, the individual may initially depress the button 406 to set the timer at two hours, and prior to two hours expiring, depress the button 406 again to reset the timer to two hours (without opening the circuits 304a and 304b).

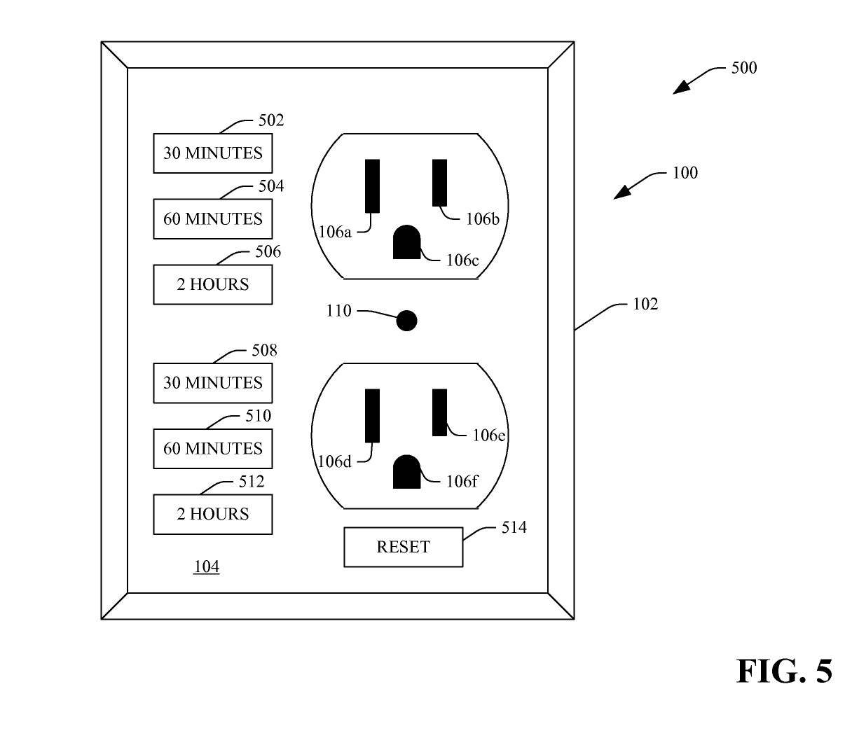

With reference now to FIG. 5, another example embodiment 500 of the apparatus 100 is illustrated. In the depicted embodiment 500, the first electrical receptacles 106a, 106b, and 106c have a first plurality of buttons 502, 504, and 506 corresponding thereto, and the first electrical receptacles 106d, 106e, and 106f have a second plurality of buttons 508, 510, and 512 corresponding thereto. In other words, the electrical receptacles 106a, 106b, and 106c have a first timer corresponding thereto, and the electrical receptacles 106d, 106e, and 106f have a second timer corresponding thereto.

Each of the buttons 502-512 corresponds to a particular duration of time. Pursuant to an example, a toaster may be plugged into the receptacles 106a, 106b, and 106c, and a telephone charging device may be plugged into the electrical receptacles 106d, 106e, and 106f. An individual may depress the button 502, such that electrical power is provided to the toaster for thirty minutes. An individual may also depress the button 512, such that electrical power is provided to the charging device for two hours. Timers can be set in accordance with the selected buttons 502 and 512, and the switches 304a and 304b can be closed for the times corresponding to the selected buttons 502 and 512. After the time(s) have passed, the switches 304a and 304b return to the default (open) position.

The apparatus 100 also includes a reset button 514, which can reset both switches 304a and 304b to the default, open position, thereby preventing electrical power to be provided to one or more devices plugged into the receptacles 106 of the apparatus 100. In another embodiment, the electrical receptacles 106a, 106b, and 106c can have a first reset button corresponding thereto, and the electrical receptacles 106d, 106e, and 106f can have a second reset button corresponding thereto. Accordingly, each timer can individually be reset.

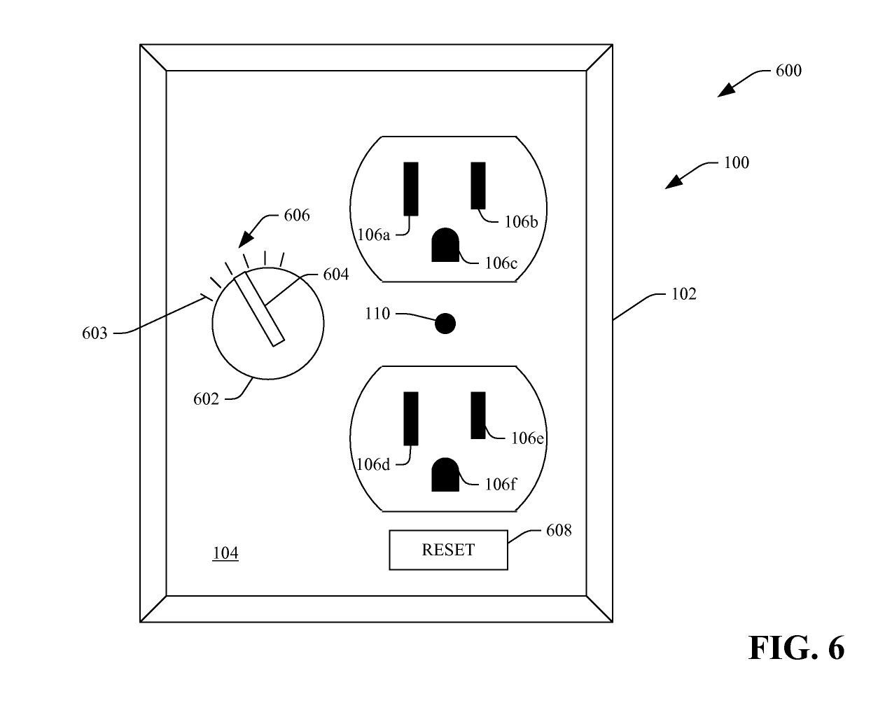

Referring now to FIG. 6, an example embodiment 600 of the apparatus 100 is illustrated. In the depicted embodiment 600, the apparatus 100 includes a rotatable dial 602 that can be rotated to set the timer 302. For instance, the dial 602 may initially be set in a default position 603, wherein such position corresponds to the circuits 304a and 304b being open. An individual may rotate the dial 602 in a clockwise direction, until a pointer 604 points to a time period desired by the individual. Time periods may be illustrated to the user through use of markings 606 on the front 104 of the housing 102. Using such a configuration, the timer 302 and switches 304a and 304b may be entirely mechanical in nature. For instance, rotation of the dial 602 may close the switches 304a and 304b and wind a spring that is used in connection with the timer. As the spring releases energy, the dial pointer 604 on the dial 602 returns to the default position. Upon reaching the default position, a mechanical linkage can be used to open the circuits 304a and 304b.

In the example embodiment 600, a single rotatable dial is used to set a single timer that is included in the apparatus 100, and the timer is used to control the switches 304a and 304b corresponding to both sets of electrical receptacles 106. It is to be understood, however, that the apparatus 100 may include multiple timers that may be set using multiple rotatable dials that are placed on the front 104 of the housing 102. The example embodiment 600 may optionally include a reset button 608 that can open the circuits 304a and 304b upon depression thereof. Alternatively, an individual may manually rotate the rotatable dial 602 in a counterclockwise direction until the rotatable dial is in the default position 603.

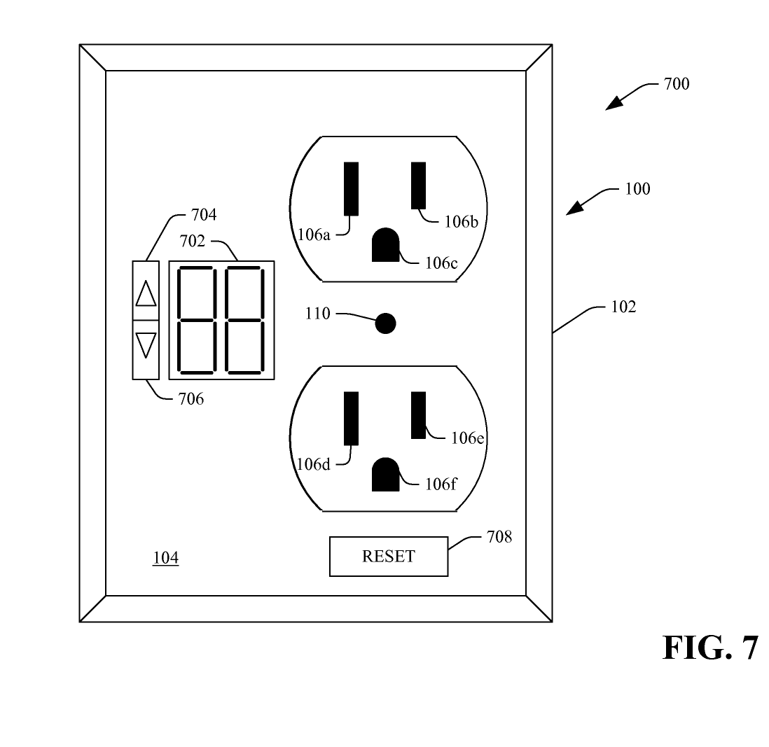

Now turning to FIG. 7, an example embodiment 700 of the apparatus is illustrated.

In the depicted embodiment 700, the apparatus 100 includes a digital interface 702 positioned on the front 104 of the housing 102. The digital interface 702 depicts an amount of time that electrical power will be received by a device plugged into the apparatus 100. While shown as being capable of displaying two numbers, it is to be understood that the digital interface 702 may be capable of displaying three or more numbers simultaneously. Furthermore, the digital interface 702 may include a portion thereon that indicates which time unit is represented by displayed numbers (e.g., days, hours, minutes, seconds).

Depressible buttons 704 and 706 are also positioned on the front 104 of the housing 102. Depression of the buttons 704 may facilitate setting the timer 302 of the apparatus 100. For instance, depression of the button 704 may cause an amount of time for which the timer 302 is set to increase, while depression of the button 706 may cause the amount of time for which the timer 302 is set to decrease. Other functional, depressible buttons may also be included on the front 102 of the housing 104. For instance, a button (not shown) may be used to change a unit of time displayed by the digital interface 702 (e.g., from minutes to hours). Furthermore, as noted above, the apparatus 100 may include multiple timers (e.g., a timer for each set of electrical receptacles on the apparatus 100). Accordingly, the digital interface 702 and depressible buttons 704 and 706 may be duplicated such that each timer in the apparatus 100 has a corresponding digital interface mechanism for setting the timer. The apparatus 100 may optionally include a reset button 708 that can reset one or more of the timers and can cause one or more switches 304a or 304b to be placed in a default, open position.

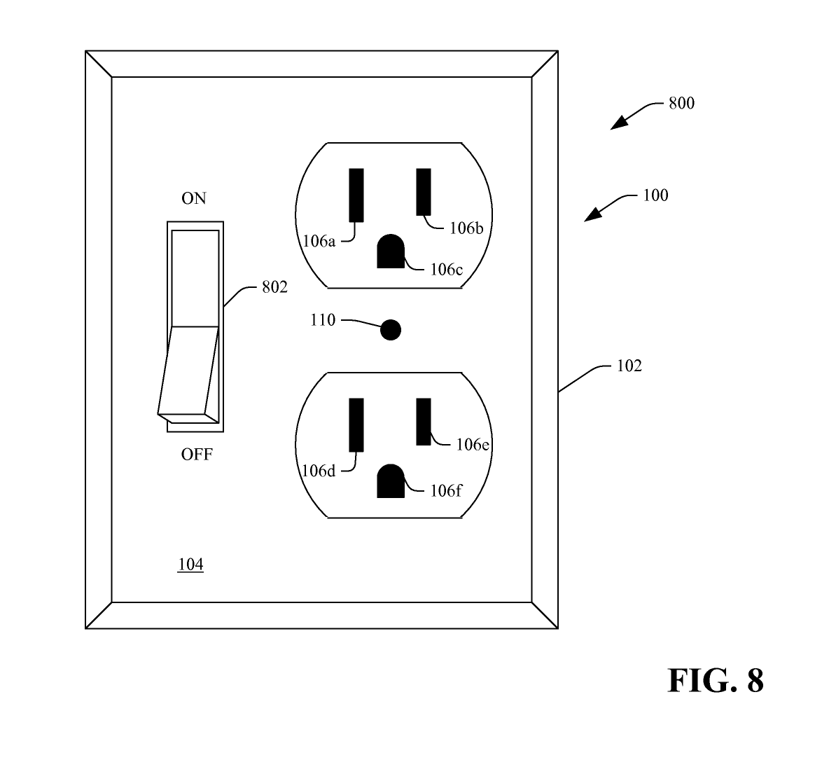

Turning now to FIG. 8, an example embodiment 800 of the apparatus 100 is illustrated. In the depicted embodiment, a light-switch mechanism 802 can be used to manually open or close the switches 304a and 304b without use of a timer. Placing the light-switch mechanism 802 in the “on” position causes electrical power to be provided to a device plugged into the apparatus 100, while placing the light-switch mechanism 802 in the “off” position prevents electrical power from being provided to a device that is plugged into the apparatus 100. In another embodiment, placing the light-switch mechanism in the “on” position may cause electrical power to be provided to a device plugged into the apparatus 100 for a particular period of time (e.g., two hours, four hours, . . . ). After passage of the particular period of time, the light-switch mechanism 802 can automatically revert to a default “off” position.

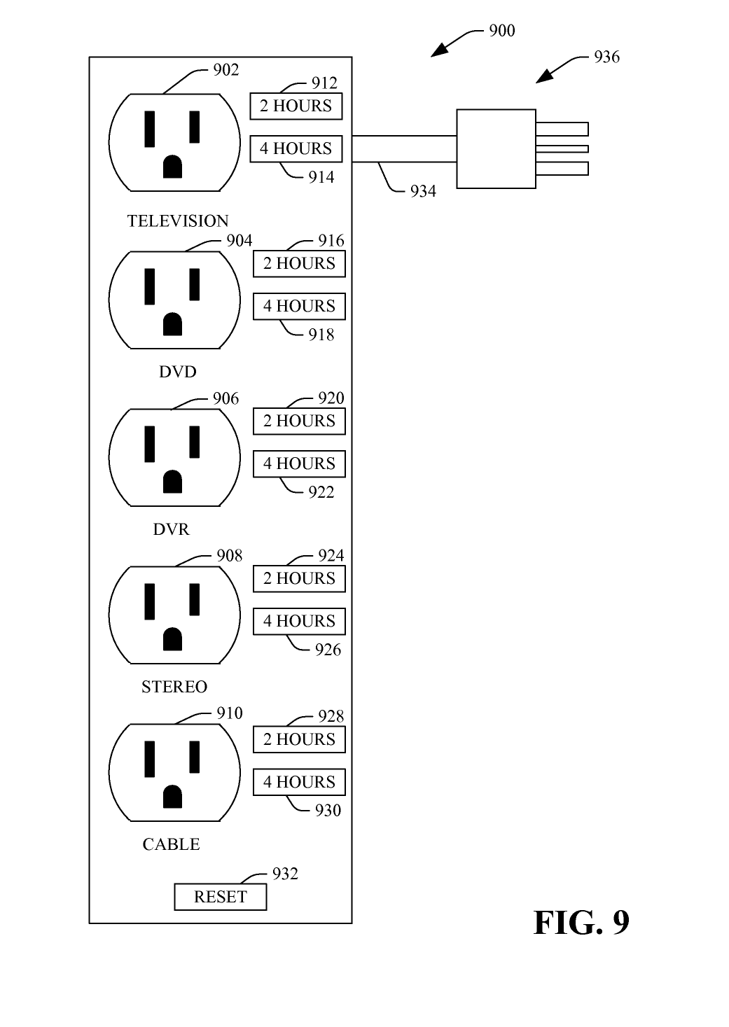

With reference now to FIG. 9, an example apparatus 900 that facilitates reducing an amount of electrical power used by devices when such devices are not actively being used (e.g., the devices may in a “standby” mode) is illustrated. The apparatus 900 includes several sets of electrical receptacles. More specifically, the apparatus 900 includes a first set of electrical receptacles 902, a second set of electrical receptacles 904, a third set of electrical receptacles 906, a fourth set of electrical receptacles 908, and a fifth set of electrical receptacles 910. The first set of electrical receptacles 902 may be configured to receive a television, the second set of electrical receptacles 904 may be configured to receive a DVD player/recorder, the third set of electrical receptacles 906 may be configured to receive a digital video recorder (DVR), the fourth set of electrical receptacles 908 may be configured to receive a stereo, and the fifth set of electrical receptacles 910 may be configured to receive a cable box or other suitable set top box.

Each of the sets of electrical receptacles can have corresponding input receiver mechanisms that facilitate setting a timer that corresponds to the electrical receptacles. For instance, the first set of electrical receptacles 902 may have two depressible buttons 912 and 914 corresponding thereto. If the button 912 is depressed, a timer corresponding to the first set of electrical receptacles 902 can be set for two hours. In other words, a switch (with a default position of open) can be closed for two hours, and then automatically opened upon passage of two hours. Thus, for instance, a television that is plugged into the first set of electrical receptacles 902 may be provided with electrical power for two hours. In addition, depressible buttons 916 and 918 can correspond to the second set of electrical receptacles 904, depressible buttons 920 and 922 can correspond to the third set of electrical receptacles 906, depressible buttons 924 and 926 can correspond to the fourth set of electrical receptacles 908, and depressible buttons 928 and 930 can correspond to the fifth set of electrical receptacles 910. As noted above, each of the depressible buttons can be used to set timers corresponding to the sets of electrical receptacles. While depressible buttons are depicted, it is to be understood that other mechanisms may be used to set timers corresponding to the electrical receptacles. For instance, rotatable dials, sliders, digital interfaces, touch pads, microphones for receiving voice commands, and other suitable mechanisms may be used to set timers. Moreover, as will be shown below, timers can be set by way of a remote control.

The apparatus 900 further includes a reset button 932 that facilitates resetting all timers and placing each of the switches in the apparatus 900 in a default, open position. Thus, when the reset button 932 is depressed devices plugged into the sets of electrical receptacles 902-910 will not receive electrical power.

The apparatus 900 may additionally include a cord 934, wherein a plug 936 is positioned at an end of the cord 934. The cord 934 allows the apparatus 900 to be positioned at a distance from a wall outlet. More particularly, the plug 936 can be plugged into a wall outlet, and electrical power to particular devices can be regulated at each set of electrical receptacles 902-910. An example placement of such an apparatus is discussed below.

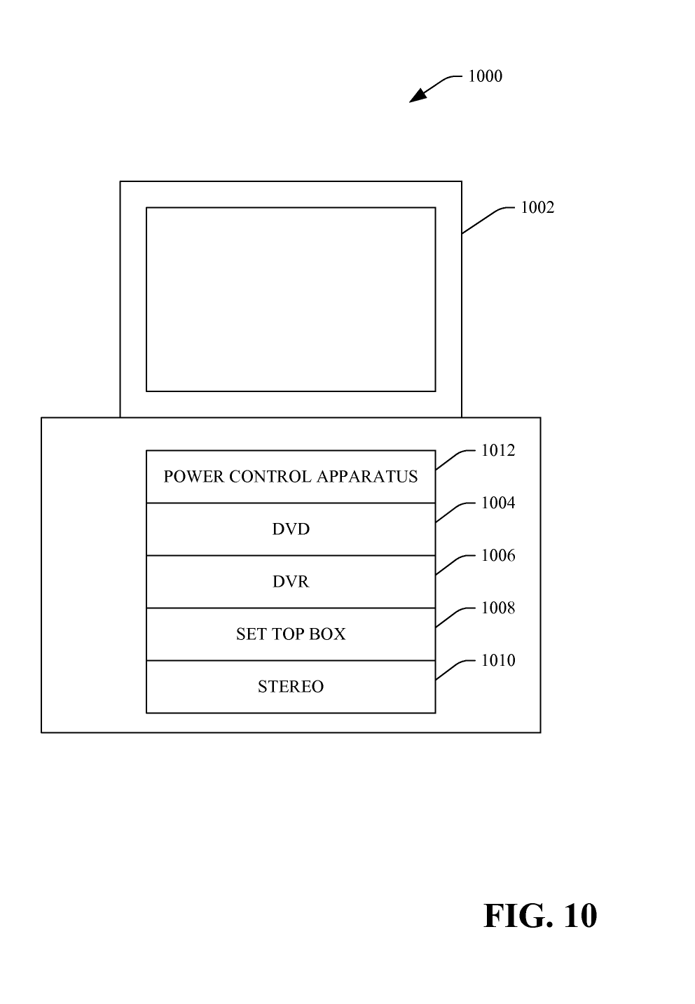

With reference now to FIG. 10, an example configuration 1000 of electrical devices is depicted. The configuration 1000 includes a television 1002, a DVD player 1004, a digital video recorder 1006, a set-top box 1008, and a stereo 1010. Each of these devices may be plugged into a power control apparatus 1012, such as the apparatus 900 (FIG. 9). The power control apparatus 1012 may be plugged into a standard wall outlet and placed proximate to the other devices 1002-1010, such that the devices 1002-1010 can be plugged into the power control apparatus 1012. The power control apparatus 1012, as described above, can include several electrical receptacles that can have mechanisms corresponding thereto that allow an individual to control an amount of time that power is provided to the devices 1002-1010.

Pursuant to one example, a remote control can be configured to set timers in the power control apparatus 1012. In another example, the power control apparatus 1012 can be configured to receive commands from remote controls of one or more of the devices 1002-1010 and can cause switches to be closed and opened in response to such commands. Pursuant to an example, the default position of a switch in the power control apparatus 1012 may be open, such that electrical current does not flow to a device plugged into electrical receptacles of the power control apparatus 1012. When a power button on a remote control of the television is depressed, the power control apparatus 1012 can detect such depression and close the switch. Accordingly, electrical current can flow to the television when the power button for the television on the remote control is depressed.

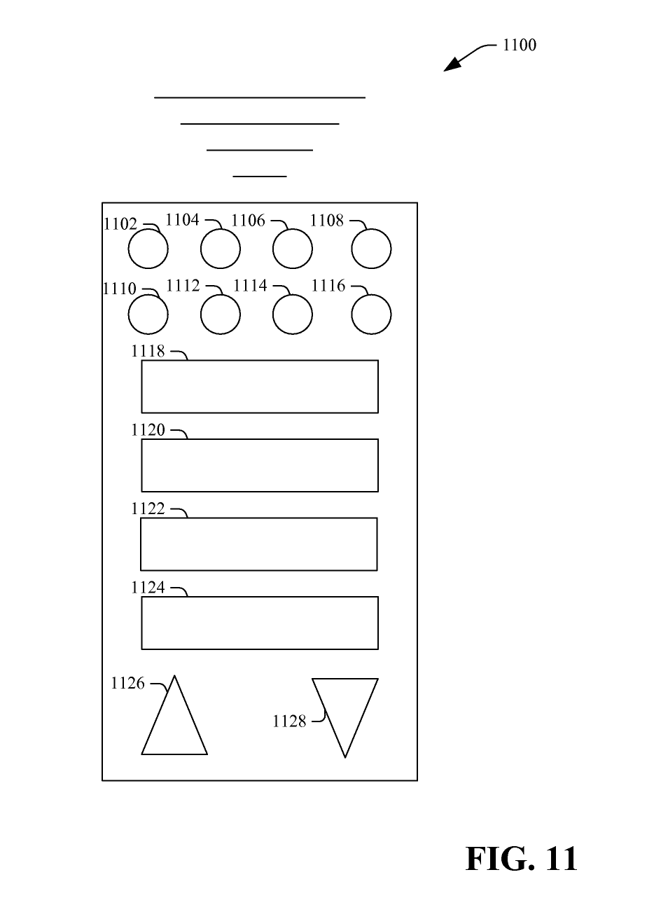

Referring now to FIG. 11, an example remote control 1100 that can be used in connection with setting a timer in a power control apparatus is illustrated. The remote control 1100 may include several buttons 1102, 1104, 1106, 1108, 1110, 1112, 1114, and 1116, wherein the buttons may correspond to a particular electrical device and/or particular electrical receptacles in a power control apparatus (such as the apparatuses shown in FIGS. 1-9). For instance, the button 1102 may correspond to a television, the button 1104 may correspond to a DVD player, etc. Additionally, the remote control 1100 may include numerous buttons 1118, 1120, 1122, and 1124 that correspond to particular time periods. The timer periods may be used to set a timer in a power control apparatus. Furthermore, the remote control 1100 may include buttons 1126 and 1128 that can be used to incrementally change a time period when setting a timer.

Pursuant to an example, an individual may depress the button 1112, which may correspond to a stereo system. The individual may then depress the button 1122, which corresponds to a two hour timer period. Thus, a timer in a power control apparatus corresponding to the stereo system may be set for two hours (e.g., a switch in the power control apparatus will be closed for two hours and thereafter revert to the default open position). To incrementally increase the set time, the individual can depress the button 1126, which may cause the set time to be incremented by an hour, for example. While not shown, the remote control 1100 may include a reset button that facilitates placing a plurality of power control apparatuses in a default configuration. Of course, other configurations of a remote control are contemplated and intended to fall under the scope of the hereto-appended claims.

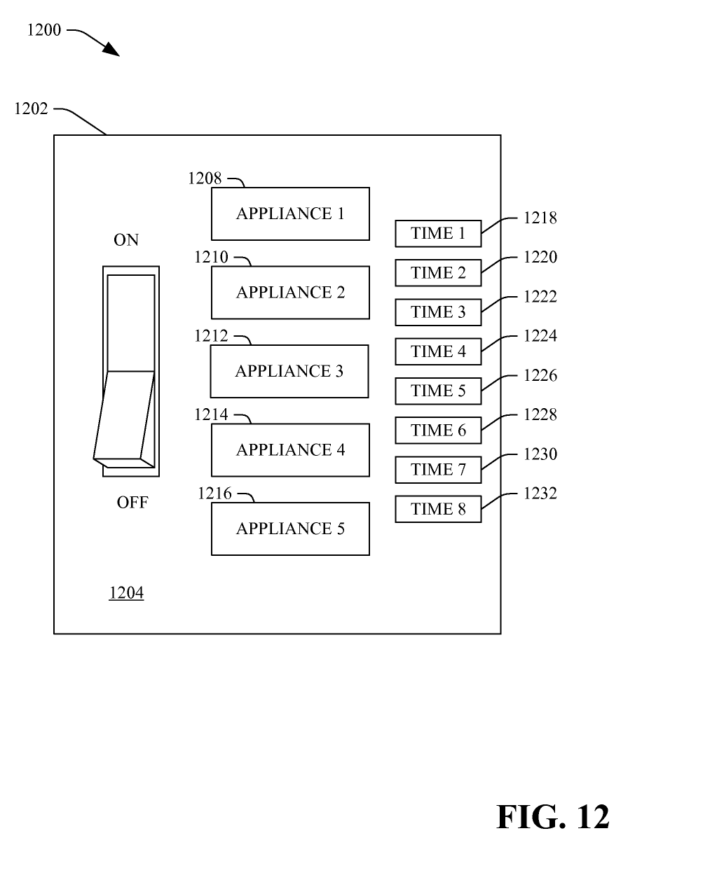

With reference now to FIG. 12, an example apparatus 1200 that facilitates setting timers in one or more power control apparatuses is illustrated. The apparatus 1200 includes a housing 1202, wherein the housing has a front 1204 and a back (not shown). A light-switch type mechanism 1206 can be used to turn the apparatus 1200 “on” or “off”. When the apparatus 1200 is off, depressible buttons on the apparatus 1200 may be nonfunctional. The apparatus 1200 is illustrated as including several depressible buttons. Specifically, the apparatus 1200 includes depressible buttons 1208, 1210, 1212, 1214, and 1216 that are positioned on the front 1204 of the housing 1202. Each of these buttons 1208-1216 may correspond to a particular apparatus and/or set of electrical receptacles. For instance, the button 1208 may correspond to a first appliance (e.g., toaster) and/or a first set of electrical receptacles (e.g., electrical receptacles that receive a plug of a toaster). Another set of depressible buttons 1218, 1220, 1222, 1224, 1226, 1228, 1230, and 1232 may also be positioned on the front 1204 of the housing 1202. The buttons 1218-1232 may each correspond to a particular period of time, and can be used to set timers of power control apparatuses.

Pursuant to an example, an individual may switch the light-switch mechanism 1206 to an “on” position. The individual may then wish charge a portable telephone, and the depressible button 1212 may correspond to the portable telephone. Accordingly, the individual can depress the depressible button 1212. Thereafter, the individual can select a time period that power should be provided to the charging device. For instance, the user can depress the button 1224, which corresponds to a timer period of two hours. Accordingly, the timer for the power control apparatus is set at two hours, and electrical power will be provided to the charging device through the power control apparatus for two hours. Thereafter, the power control apparatus returns to a default configuration and the charging device does not receive electrical power.

As can be discerned from the above, the apparatus 1200 may be used to set timers for multiple power control apparatuses in a household. Furthermore, while shown as including depressible buttons, it is to be understood that the apparatus 1200 may include other mechanisms to facilitate setting timers, such as digital interfaces, sliders, microphones for receiving voice input, and the like.

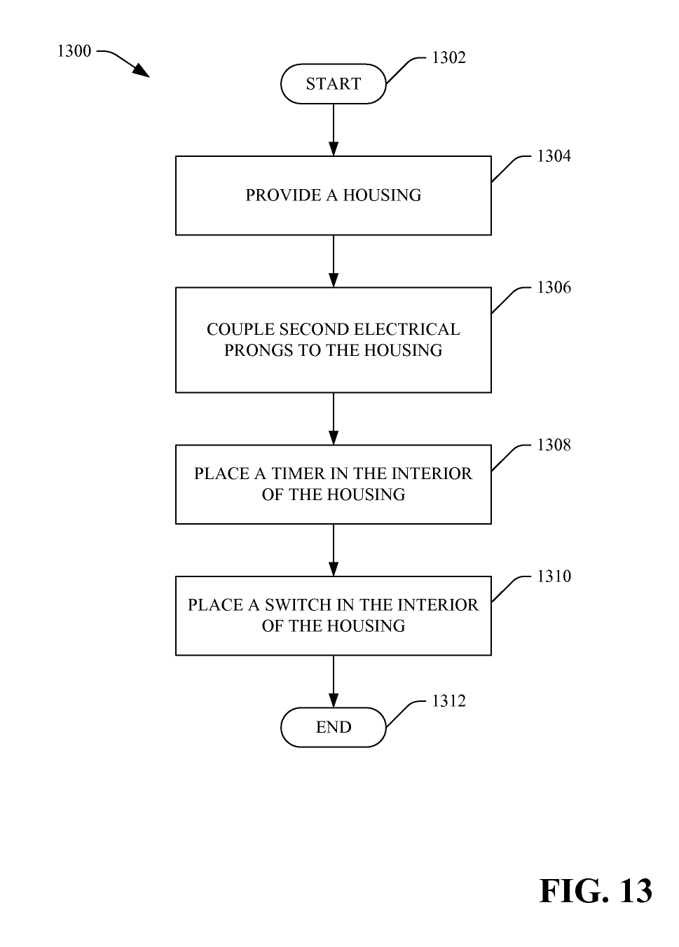

Now referring to FIG. 13, an example methodology 1300 is illustrated. While the methodology 1300 is shown as a sequence of acts, it is to be understood that these acts can be performed in a different sequence than what is depicted. Furthermore, not all acts may be needed to undertake a methodology that falls under the scope of the hereto-appended claims.

The methodology 1300 starts at 1302, and at 1304 a housing is produced. The housing may include a front, a back, an interior, and first electrical receptacles that are configured to receive first electrical prongs of an electrical apparatus. At 1306, second electrical prongs are coupled to the housing. In an example, the second electrical prongs may be coupled directly to the back of the housing extending away from the housing. In another example, the second electrical prongs may be coupled to the housing by way of one or more cables and a plug. The second electrical prongs can correspond to the first electrical receptacles and may be configured to be received by second electrical receptacles of an electrical wall outlet.

At 1308, a timer is placed in the interior of the housing. The timer, for instance, may be configured to output a signal upon passage of a defined amount of time. At 1310, a switch can be placed in the interior of the housing, wherein the switch is communicatively coupled with the timer. Prior to receipt of the signal from the timer, the switch can be operative to electrically couple the electrical apparatus with the second electrical receptacles, wherein in response to receipt of the signal from the timer the switch is operative to electrically disconnect the electrical apparatus from second electrical receptacles.

In the foregoing description certain terms have been used for brevity, clarity and understanding, however no unnecessary limitations are to be implied therefrom because such terms are used for descriptive purposes and are intended to be broadly construed. Moreover, the descriptions and illustrations herein are by way of examples, and the examples are not limited to the exact details shown and described.

In the specification example manners/mechanisms and materials may have been recited; however, any manner/mechanism or material is intended to fall under the scope of the hereto appended claims.

Having described the features, discoveries and principles of the examples, the manner in which they are constructed and operated, and the advantages and useful results attained; the new and useful structures, devices, elements, arrangements, parts, combinations, systems, equipment, operations, methods and relationships are set forth in the appended claims.

What is claimed is:

1. An apparatus, comprising:
a housing, wherein the housing has a front and a back, wherein the housing includes first electrical receptacles, a switch, and a timer module, wherein the first electrical receptacles are positioned on the front of the housing and are configured to receive first prongs of an electric plug, and wherein the switch is responsive to the timer; and
second prongs that correspond to the first electrical receptacles, wherein the second prongs are coupled to the back of the housing and are configured to be received by second electrical receptacles of an outlet socket, wherein the switch, when closed, is operative to electrically couple at least one of the first prongs with at least one of the second electrical receptacles, wherein the switch, when open, is operative to prevent electrical coupling of the at least one of the first prongs with the at least one of the second receptacles, and wherein the timer is operative to cause the switch to be opened and closed.

2. The apparatus of claim 1, wherein the second prongs are coupled to the back of the housing by way of a cable and plug.

3. The apparatus of claim 1, further comprising a timer switch that is positioned on the front of the housing, wherein the timer switch is operative to receive user input, and wherein the timer is initiated in response to the timer switch receiving user input.

4. The apparatus of claim 3, wherein the timer switch comprises a depressible button.

5. The apparatus of claim 3, wherein the timer comprises a rotatable dial, wherein an amount that a user rotates the dial corresponds to an amount of time that passes prior to the switch being opened.

6. The apparatus of claim 1, further comprising a plurality of timer switches that are positioned on the front of the housing, wherein each of the plurality of timer switches is operative to receive user input, wherein each of the timer switches corresponds to a different defined amount of time, and wherein the timer is initiated upon any of the plurality of timer switches receiving user input.

7. The apparatus of claim 6, wherein a first timer switch corresponds to a five minute period of time, a second timer switch corresponds to a ten minute period of time, and a third time switch corresponds to an hour period of time.

8. The apparatus of claim 3, wherein the timer switch comprises a digital interface that presents the defined amount of time to a user.

9. The apparatus of claim 8, further comprising a depressible button that facilitates altering the defined amount of time.

10. The apparatus of claim 1, wherein the first electrical receptacles are configured to receive a plug of an electrical device that draws power while in standby mode.

11. The apparatus of claim 10, wherein the electrical device is one of a toaster, a curling iron, or a charging apparatus.

12. The apparatus of claim 1, wherein the housing includes an aperture therethrough that is configured to receive a threaded screw, wherein the threaded screw facilitates attachment of the apparatus to a wall that supports the outlet socket.

13. The apparatus of claim 1, further comprising a reset switch that is positioned on the front of the housing, wherein the reset switch facilitates disablement of the timer.

14. The apparatus of claim 1, further comprising a wireless transceiver that is configured to receive wireless communications, wherein the wireless communications facilitate setting the defined period of time of the timer.

15. The apparatus of claim 14, wherein the wireless transceiver is configured to receive wireless communications from a remote control apparatus.

16. The apparatus of claim 1, further comprising a flippable switch that is positioned on the exterior of the housing, wherein flipping of the flippable switch facilitates selecting the defined period of time.

17. The apparatus of claim 1, further comprising a battery receiver portion that is configured to receive a battery and electrically couple the battery to the timer.

18. The apparatus of claim 1, further comprising a timer programmer that is configured to set the timer to the defined amount of time upon receipt of user input.

19. The apparatus of claim 1, wherein the switch is operative to prevent a hot prong in the first prongs with electrically coupling to a corresponding prong in the second prongs.

20. The apparatus of claim 1, further comprising:
third electrical receptacles that are positioned on the front of the housing and are configured to receive third prongs of an electrical apparatus; and
fourth prongs that extend from the back of the housing, wherein the fourth prongs correspond to the third electrical receptacles, wherein the fourth prongs are configured to be received by fourth electrical receptacles in a wall outlet.

21. The apparatus of claim 1, wherein the first electrical receptacles are positioned vertically above the third electrical receptacles on the front of the housing.

22. The apparatus of claim 1, wherein the housing is made of one of a plastic or carbon fiber material.

23. The apparatus of claim 1, wherein the timer is one of a mechanical timer, an electromechanical timer, an optomechanical timer, or a digital timer.

24. A method, comprising:
producing a housing, wherein the housing includes a front, an interior, and first electrical receptacles that are configured to receive first electrical prongs of an electrical apparatus;
coupling second electrical prongs to the housing, wherein the second electrical prongs correspond to the first electrical receptacles and are configured to be received by second electrical receptacles of an electrical wall outlet;
placing a timer in the interior of the housing;
placing a switch in the interior of the housing, wherein the switch operatively coupled to the timer, wherein prior to the timer being initiated the timer is operative to place the switch in a position to prevent electrical current from being provided to the first electrical receptacles from the electrical wall outlet, wherein once initiated the timer is operative to place the switch in a position to allow electrical current to be provided to the first electrical receptacles from the electrical wall outlet, wherein after passage of a defined amount of time the timer is operative to place the switch in a position to prevent current from being provided to the first electrical receptacles from the electrical wall outlet.

25. The method of claim 24, further comprising configuring the timer to be programmable by way of a remote control.

26. The method of claim 24, further comprising placing a battery receiving compartment in the interior of the housing, wherein the battery receiving compartment is configured to receive a battery that is operative to provide electrical power to the timer.

27. The method of claim 24, wherein the second electrical prongs are coupled to the housing by way of a cable and plug.
